(19) United States
(12) Patent Application Publication
(10) Pub. No.: US 2020/0257031 A1
(43) Pub. Date: Aug. 13, 2020

(54) DISPLAY DEVICE

(71) Applicant: Samsung Display Co., LTD., Yongin-si (KR)

(72) Inventors: Younggyu JUNG, Seongnam-si (KR); Yongjun LEE, Hwaseong-si (KR)

(21) Appl. No.: 16/733,642

(22) Filed: Jan. 3, 2020

(30) Foreign Application Priority Data
Feb. 13, 2019 (KR) 10-2019-0016544

(51) Int. Cl. F21V 8/00

(52) U.S. Cl. CPC G02B 6/0023; G02B 6/0088; G02B 6/0043

(57) ABSTRACT

A display device includes a light source; a light guide plate which includes a light incident surface; a circuit board which provides power to the light source and faces the light incident surface; a light guide plate alignment member between the circuit board and the light incident surface; and a frame to which the light guide plate alignment member is coupled. The light guide plate alignment member includes: a gap maintaining portion between the circuit board and the light incident surface; a securing portion with which the light guide plate alignment member is coupled to the frame, and a first alignment portion connecting the gap maintaining portion and the securing portion to each other with the circuit board therebetween, the first alignment portion contacting both an upper surface of the circuit board and an upper surface of the light guide plate.

This application claims priority to Korean Patent Application No. 10-2019-0016544, filed on Feb. 13, 2019, and all the benefits accruing therefrom under 35 U.S.C. § 119, the disclosure of which is incorporated by reference herein in its entirety.

### BACKGROUND

### 1. Field

Embodiments of the invention relate to a display device, and more particularly, to a display device having an alignment structure of a light source and a light guide plate so that light emitted from the light source is incident to the light guide plate without loss.

### 2. Description of the Related Art

In general, a viewing angle difference occurs when a center portion of a display screen is viewed and when left and right ends of the display screen are viewed. In order to compensate for such a viewing angle difference, a display device and/or the display screen thereof may be curved in a concave or convex shape.

### SUMMARY

Embodiments are directed to a display device having an alignment structure of a light source and a light guide plate so that light emitted from the light source is incident to the light guide plate without loss.

According to an embodiment, a display device includes: a light source; a light guide plate which includes a light incident surface; a circuit board which provides power to the light source and faces the light incident surface; a light guide plate alignment member between the circuit board and the light incident surface; and a frame to which the light guide plate alignment member is coupled. The light guide plate alignment member includes: a gap maintaining portion between the circuit board and the light incident surface; a securing portion with which the light guide plate alignment member is coupled to the frame, and a first alignment portion connecting the gap maintaining portion and the securing portion to each other with the circuit board therebetween, the first alignment portion contacting both an upper surface of the circuit board and an upper surface of the light guide plate.

The frame may include an upper frame, an intermediate frame and a lower frame. The lower frame may be coupled to the light guide plate alignment member.

The light source may include a plurality of light emitting diode packages. The light guide plate alignment member may be disposed between light emitting diode packages which are adjacent to each other.

The circuit board may define a coupling depression in which the first alignment portion of the light guide plate alignment member is accommodated, the first alignment portion contacting the upper surface of the circuit board at the coupling depression thereof.

A thickness of a portion of the first alignment portion at which the upper surface of the circuit board contacts the first alignment portion may be greater than a thickness of a portion of the first alignment portion at which the upper surface of the light guide plate contacts the first alignment portion.

The first alignment portion may have a width substantially equal to a width of the gap maintaining portion.

The first alignment portion may have a width different from a width of the gap maintaining portion.

The first alignment portion may have a width greater than the width of the gap maintaining portion.

The securing portion may extend perpendicularly from the first alignment portion and parallel to the gap maintaining portion.

The securing portion may have a width greater than a width of both the first alignment portion and a width of the gap maintaining portion.

The frame may define a first depression in which the securing portion is accommodated to couple the frame to the light guide plate alignment member.

The frame may define a second depression into which a portion of the circuit board extends.

According to another embodiment, a display device includes: a display panel; a light source which generates light; a light guide plate which guides the light from the light source and emits the light to the display panel, the light guide plate including a light incident surface through which the light is incident to the light guide plate from the light source; a circuit board which provides power to the light source and is disposed facing the light incident surface of the light guide plate; a light guide plate alignment member disposed between the circuit board and the light incident surface of the light guide plate; and a frame in which the light guide plate and the circuit board are accommodated and to which the light guide plate alignment member is coupled. The light guide plate alignment member includes: a first alignment portion contacting an upper surface of the light guide plate; a gap maintaining portion extending from the first alignment portion to be disposed between the circuit board and the light incident surface of the light guide plate; a securing portion with which the light guide plate alignment member is coupled to the frame, the securing portion disposed between the circuit board and the frame; and a second alignment portion connecting the gap maintaining portion and the securing portion to each other with the circuit board therebetween, the second alignment portion contacting a lower surface of the circuit board.

The frame may define a first depression in which the securing portion is accommodated to couple the frame to the light guide plate alignment member.

The first alignment portion may have a width substantially equal to a width of the gap maintaining portion.

The first alignment portion may have a width different from a width of the gap maintaining portion.

The securing portion may have a width different from a width of the first alignment portion.

The securing portion may have a width greater than the width of the first alignment portion.

The gap maintaining portion may have a thickness different from a thickness of the first alignment portion.

The gap maintaining portion may have a thickness greater than the thickness of the first alignment portion.

The foregoing is illustrative only and is not intended to be in any way limiting. In addition to the illustrative embodiments and features described above, further embodiments and features will become apparent by reference to the drawings and the following detailed description.

### BRIEF DESCRIPTION OF THE DRAWINGS

A more complete appreciation of the invention will become more apparent by describing in detail embodiments thereof with reference to the accompanying drawings, where:

FIG. 1 is an exploded perspective view schematically illustrating an embodiment of a display device;

FIG. 2 is a cross-sectional view illustrating the display device taken along line I-I′ in FIG. 1;

FIG. 3 is a cross-sectional view illustrating an embodiment of a display device taken along line II-II′ in FIG. 1;

FIG. 4 is an enlarged cross-sectional view illustrating a light guide plate alignment member relative to a circuit board;

FIG. 5 is a cross-sectional view taken along line A-A′ in FIG. 4;

FIG. 6 is a view illustrating an embodiment of a light guide plate alignment member relative to a light guide plate and a circuit board;

FIG. 7 is a view illustrating an embodiment of a light guide plate alignment member;

FIG. 8 is a view illustrating the light guide plate alignment member of FIG. 7 viewed from a different angle;

FIG. 9 is an enlarged view illustrating an embodiment of a connection structure of the circuit board and a frame;

FIG. 10 is a view illustrating an embodiment of a connection structure in which a light guide plate alignment member is coupled to a circuit board and a frame, before alignment of such connection structure with a light guide plate;

FIG. 11 is a view illustrating an embodiment of a light guide plate alignment member connected to a frame, a circuit board and a light guide plate;

FIG. 12 is a view illustrating another embodiment of a light guide plate alignment member;

FIG. 13 is a view illustrating an embodiment of a connection structure in which a light guide plate alignment member is coupled to a circuit board and a frame, before alignment of such connection structure with a light guide plate;

FIG. 14 is a view illustrating an embodiment of a light guide plate alignment member connected to a frame, a circuit board and a light guide plate;

FIG. 15 is a cross-sectional view taken along line B-B′ in FIG. 13;

FIG. 16 is an enlarged cross-sectional view illustrating a light guide plate alignment member between two circuit boards;

FIG. 17 is a view illustrating still another embodiment of a light guide plate alignment member;

FIG. 18 is a view illustrating an embodiment of a connection structure in which a light guide plate alignment member is coupled to two circuit boards and a frame, before alignment of such connection structure with a light guide plate; and

FIG. 19 is a view illustrating an embodiment of a light guide plate alignment member connected to a frame, two circuit boards and a light guide plate.

### DETAILED DESCRIPTION

Embodiments will now be described more fully hereinafter with reference to the accompanying drawings. Although the invention may be modified in various manners and have several embodiments, embodiments are illustrated in the accompanying drawings and will be mainly described in the specification. However, the scope of embodiments are not limited to the embodiments and should be construed as including all the changes, equivalents and substitutions included in the spirit and scope according to an embodiment.

In the drawings, thicknesses of a plurality of layers and areas are illustrated in an enlarged manner for clarity and ease of description thereof. When a layer, area, or plate is referred to as being related to another element such as being “on” or “below” another layer, area, or plate, it may be directly on the other layer, area, or plate, or intervening layers, areas, or plates may be present therebetween. Conversely, when a layer, area, or plate is referred to as being related to another element such as being “directly on” or “directly below” another layer, area, or plate, no intervening layers, areas, or plates are therebetween.

The spatially relative terms “below,” “beneath,” “lower,” “above,” “upper” and the like, may be used herein for ease of description to describe the relations between one element or component and another element or component as illustrated in the drawings. It will be understood that the spatially relative terms are intended to encompass different orientations of the device in use or operation, in addition to the orientation illustrated in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction and thus the spatially relative terms may be interpreted differently depending on the orientations.

Throughout the specification, when an element is referred to as being “connected” to another element, the element is “physically connected” to the other element such as being in direct contact therewith, or “electrically connected” to the other element with one or more intervening elements interposed therebetween.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Accordingly, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10% or 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined at the present specification.

Some of the parts which are not associated with the description may not be provided in order to specifically describe embodiments according to an embodiment and like reference numerals refer to like elements throughout the specification.

For a display device which is curved, a backlight unit includes a curved light guide plate. When a light source is disposed along a side surface of the curved light guide plate, aligning the light source and a light incident surface of the light guide plate to face each other may be difficult.

If the light guide plate is not properly aligned, a light incident efficiency of the light emitted from the light source being incident to the light guide plate is lowered, which causes a decrease in luminance within the display device. Conventionally, a bottom unit in which a light guide plate is housed presses a lower portion of the light guide plate and a mold frame presses an upper portion of the light guide plate, thereby guiding the light guide plate to be aligned with the light source.

However, as a display device is made slimmer, a gap between a display panel and an optical sheet is reduced, and performing molding and/or forming components (e.g., a mold frame) of the display device by molding becomes difficult. Accordingly, the light guide plate is not precisely aligned with the light source, thus undesirably increasing the light loss.

In addition, in a display device which is curved, a curvature of a circuit board of the light source does not coincide with a curvature of the mold, and when the circuit board of the light source is mounted, a gap is undesirably generated between the mold frame and the light guide plate due to work or manufacturing tolerances in forming components of the display device. Accordingly, the light source is not precisely aligned with the light guide plate, and the light loss increases.

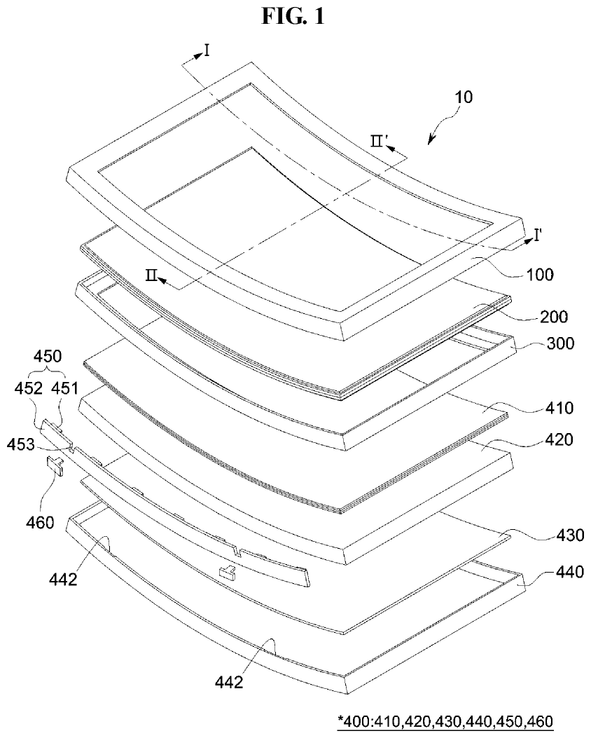

Hereinafter, a display device will be described in detail with reference to FIGS. 1 to 19.

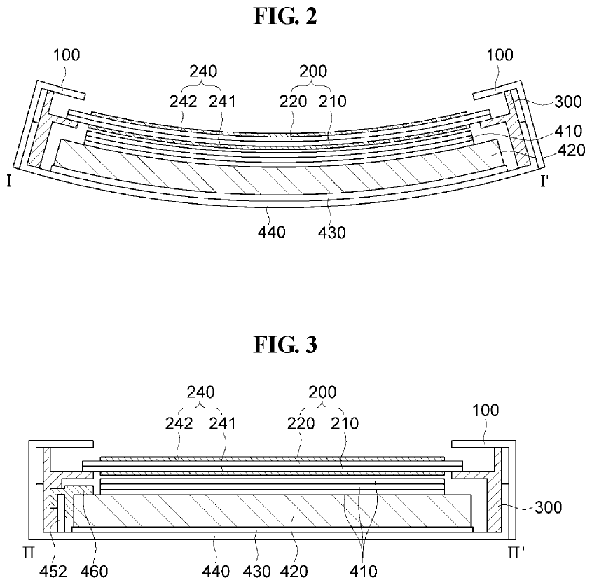

FIG. 1 is an exploded perspective view schematically illustrating an embodiment of a display device, and FIG. 2 is a cross-sectional view illustrating the display device taken along line I-I′ in FIG. 1.

Referring to FIGS. 1 and 2, a display device 10 may have a predetermined radius of curvature. That is, the display device 10 is a curved type display device in which opposite sides are roundly curved with respect to a center portion of the display device 10.

The display device 10 includes a display panel 200, a backlight unit 400 generating and providing light to the display panel 200, an upper frame 100 provided in a shape corresponding to a shape of the display panel 200 and covering the display panel 200, and an intermediate frame 300 in which the display panel 200 is seated. Each of the aforementioned elements has a shape which is roundly curved corresponding to the curved shape of the display device 10.

The upper frame 100 is coupled to a lower frame 440 to cover the display panel 200 seated on the intermediate frame 300. The upper frame 100 is provided at its center portion with an opening window through which the display panel 200 is exposed. The upper frame 100 may be disposed so as to cover an edge of an upper surface and a side surface of the display panel 200.

The upper frame 100 may be coupled to the lower frame 440 such as through a screw connection. In addition, the coupling of the upper frame 100 and the lower frame 440 to each other may be modified in various forms. An embodiment of a coupling structure of the upper frame 100 and the lower frame 440 will be described below. As used herein, the upper frame 100, the intermediate frame 300 and the lower frame 440 may be collectively referred to as a ‘frame’ or ‘chassis’. The frame may be divided and called an upper chassis portion 100, an intermediate chassis portion 300, and a lower chassis portion 440, for example.

The display panel 200 has a predetermined radius of curvature. Two relatively long sides (hereinafter, “long sides”) of the display panel 200 have concavely curved shapes with a constant curvature, and two relatively short sides (hereinafter, “short sides”) have a straight line shape. Alternatively, the display panel 200 may have a shape in which the short sides are curved concavely with a predetermined curvature, and the long sides may have a straight shape.

The display panel 200 may include a flexible material. In an embodiment, the display panel 200 which is flat may be curved after being disposed at the lower frame 440, the intermediate frame 300 and the upper frame 100. That is, the lower frame 440, the intermediate frame 300, and the upper frame 100 secure the display panel 200 so that the display panel 200 has a predetermined radius of curvature. Accordingly, the lower frame 440, the intermediate frame 300, and the upper frame 100 may have a predetermined radius of curvature in a shape similar to that of the display panel 200.

The display panel 200 may be curved in various ways. In an embodiment, for example, when a direction in which the display panel 200 displays images is defined as an upward direction, and a direction opposite to the upward direction is defined as a downward direction, the display panel 200 may be curved convexly in the downward direction or in the upward direction. However, the curve direction of the display panel 200 is not limited thereto. In an embodiment, for example, a central portion of the display panel 200 may be convex in the upward direction, that is, convex toward a viewing side of the display device 10 (e.g., at the top of the view in FIG. 1). Alternatively, a portion of the display panel 200 may be convex in the upward direction, and another portion of the display panel 200 may be convex in the downward direction.

The display panel 200 displays images. The display panel 200 may generate the images by element of components of the display panel 200. The display panel 200 receives light from a light source outside of the display panel and includes, for example, a liquid crystal display (“LCD”) panel, an electrowetting display panel, an electrophoretic display panel, and a microelectromechanical systems (“MEMS”) display panel. The LCD panel will be described by way of example.

The display panel 200 includes a first substrate 210, a second substrate 220 opposing the first substrate 210, and an electro-optical active layer such as a liquid crystal layer (not illustrated) provided or formed between the first substrate 210 and the second substrate 220. The display panel 200 includes, when viewed on a plane, a display area at which images are generated and/or displayed, and a non-display area which is adjacent to the display area and at which no image is displayed The non-display area is covered by the upper frame 100.

The first substrate 210 may include a plurality of pixel electrodes (not illustrated) and a plurality of thin film transistors (not illustrated) respectively connected (e.g., in one-to-one correspondence) with the pixel electrodes. Each thin film transistor switches an electronic driving signal provided to corresponding one of the pixel electrodes. In addition, the second substrate 220 may include a common electrode (not illustrated) which forms an electric field for controlling alignment of liquid crystals together with the pixel electrodes. The display panel 200 serves to drive the liquid crystal layer to display images which are viewable at a viewing side of the display device 10.

The display device 10 may further include a driving chip (not illustrated) providing an electrical driving signal, a tape carrier package (“TCP”) on which the driving chip is mounted, and a printed circuit board (“PCB”) (not illustrated) electrically connected to the display panel 200 through the TCP. The driving chip generates the electrical driving signal for driving the display panel 200 in response to an external signal. The external signal may be a signal supplied from the printed circuit board, and the external signal may include, for example, an image signal, various control signals, and/or a driving voltage.

A polarizing plate 240 (e.g., polarizing member 240) is disposed on the display panel 200, and includes a first polarizing plate 241 and a second polarizing plate 242. The first polarizing plate 241 and the second polarizing plate 242 are disposed on respective surfaces of the first substrate 210 and the second substrate 220 that face in opposite direction to each other. That is, the first polarizing plate 241 may be attached to an outer side of the first substrate 210, and the second polarizing plate 242 may be attached to an outer side of the second substrate 220. In an embodiment, a transmission axis of the first polarizing plate 241 may be substantially perpendicular to a transmission axis of the second polarizing plate 242.

The intermediate frame 300 is coupled to the lower frame 440 and accommodates the display panel 200. The intermediate frame 300 may include a flexible material such as a plastic material to substantially prevent breakage of the display panel 200. However, embodiments are not limited thereto, and other materials may be used for the intermediate frame 300 so as to provide a same shape and function described above.

The intermediate frame 300 is provided along an edge (e.g., an outer edge) of the display panel 200 to support the display panel 200 from below the display panel 200. The intermediate frame 300 may be provided at a position corresponding to each of four sides or four edges of the display panel 200, or corresponding to at least a portion of the four sides. In an embodiment, for example, the intermediate frame 300 may have a quadrangular ring shape corresponding to each of the four sides of the display panel 200, or may have a U-like shape corresponding to three sides of the edge of the display panel 200. The intermediate frame 300 may be integrally provided or formed into a unitary structure, but may be provided or formed as a plurality of assemblies connected to each other to form the intermediate frame 300, as necessary.

In an embodiment, the intermediate frame 300 may be coupled to the upper frame 100. In an embodiment, for example, a fastening hole (e.g., a screw hole) may be defined in the upper frame 100, the lower frame 440 and the intermediate frame 300, and then the upper frame 100, the lower frame 440 and the intermediate frame 300 may be coupled together using a same fastening hole by insertion of a fastening member therein (e.g., a screw).

The backlight unit 400 includes an optical sheet 410, a light guide plate 420, a reflective sheet 430, a lower frame 440, a light source member 450 and a light guide plate alignment member 460.

The light source member 450 includes a light source 451 and a first circuit board 452 on which the light source 451 is disposed. The light source member 450 may be disposed at a corner portion or a light incident side surface of the light guide plate 420. That is, the light source member 450 may generate light and emit the light to the corner portion or the light incident side surface of the light guide plate 420.

The light source 451 may be provided in plurality (e.g., plurality of light sources 451) as a plurality of light emitting diode (“LED”) packages (e.g., a plurality of LED packages 451). The plurality of light sources 451 generate light and provide the light for the display device 10 to display image information. The light emitted from the light source 451 is guided toward the display panel 200 via the light guide plate 420 and the optical sheet 410. In order to achieve luminance uniformity of the light source member 450, the light sources 451 may be spaced apart from each other at regular intervals along a light incident surface of the light guide plate 420.

The first circuit board 452 has a roundly curved shape. The first circuit board 452 has a quadrangular shape, and the first circuit board 452 may have a reflective surface. In an embodiment, for example, a surface of a body or base the first circuit board 452 may be treated with a material having reflectivity to define the reflective surface. In addition, the first circuit board 452 may include a metal material so as to perform a heat dissipating function and a mounting function. The metal material is not limited, and various metal materials having high thermal conductivity may be used.

Such a light source member 450 may be provided or formed at one side surface, two side surfaces, or all four side surfaces of the light guide plate 420, in consideration of the size, luminance, and uniformity of the display panel 200. Alternatively, the light source member 450 may be provided or formed on at least one of corner portions of the light guide plate 420.

The light guide plate 420 is disposed adjacent to the light source member 450, and is accommodated in the lower frame 440. As illustrated in FIGS. 1 and 2, the light guide plate 420 may have a roundly curved polyhedral shape. The light guide plate 420 may include a flexible material, which is similar to a material of the display panel 200. That is, the light guide plate 420 may be initially provided in a flat shape, and then may be transformed into a curved state finally when assembled within the display device 10. Alternatively, the light guide plate 420 may be initially provided in a curved shape, and may have a relatively rigid shape that is not flexible to hold the initially-provided curved shape.

The light guide plate 420 receives the light emitted from the light source 451 through the light incident side surface, and allows the light to be emitted through a light exit surface. The light guide plate 420 uniformly supplies the light provided from the light source member 450 toward the display panel 200. The light guide plate 420 includes a light exit surface facing the display panel 200, an opposite surface (e.g., a rear surface) which is opposite to the light exit surface and faces the lower frame 440, and side surfaces which connect the light exit surface and the opposite surface to each other. One or more of the side surfaces which connect the light exit surface and the opposite surface to each other may be a light incident surface. A corner portion of the light guide plate 420 is defined where two side surfaces which are adjacent to each other meet each other. The corner portion may include a portion one or both of the two side surfaces which are adjacent to each other, and/or a portion of the light exit surface and/or the opposite surface at a region where the two side surfaces meet each other.

Although the light guide plate 420 has been described as a plate for convenience of explanation, the light guide plate 420 may be provided in the form of a sheet or a film for reducing a thickness of the display device 10. That is, the light guide plate 420 is to be understood as having both a plate and a film structure for guiding light.

The light guide plate 420 may include a material having a light transmitting property to guide light efficiently, e.g., an acrylic resin, such as polymethyl methacrylate (“PMMA”), and polycarbonate (“PC”).

A pattern may be provided or formed on at least one surface of the light guide plate 420. In an embodiment, for example, a light scattering pattern (not illustrated) may be provided or formed so that the light guided to the opposite surface thereof may be emitted upward toward the display panel 200.

The optical sheet 410 is disposed on the light guide plate 420 and serves to diffuse and collimate the light which is guided by and emitted from the light guide plate 420. The optical sheet 410 may have a roundly curved shape. The optical sheet 410 may include a flexible material, which is similar to the display panel 200. That is, the optical sheet 410 may be initially provided in a flat shape, and then, may be transformed into a curved state finally when assembled within the display device 10. Alternatively, the optical sheet 410 may be initially provided in a curved shape, and may have a relatively rigid shape that is not flexible to hold the initially-provided curved shape.

The optical sheet 410 may include, for example, a diffusion sheet, a prism sheet and/or a protective sheet. The optical sheet 410 may be provided in plurality (e.g., a plurality of optical sheets 410).

The diffusion sheet serves to diffuse the light guided by and emitted from the light guide plate 420 so as to substantially prevent the light from being partially concentrated.

The prism sheet may include triangular prisms arranged on a surface thereof into a predetermined arrangement. The prism sheet is disposed on the diffusion sheet, and serves to collimate the light diffused by the diffusion sheet in a direction perpendicular to the display panel 200.

The protective sheet may be disposed on the prism sheet. The protective sheet serves to protect a surface of the prism sheet, and to diffuse light to achieve uniform light distribution.

The reflective sheet 430 is disposed between the light guide plate 420 and the lower frame 440. The reflective sheet 430 reflects light emitted to the opposite surface of the light guide plate 420 to be directed toward the display panel 200 to improve light efficiency. The reflective sheet 430 may have a roundly curved shape.

The reflective sheet 430 may include, for example, polyethylene terephthalate (“PET”), thus having a reflective property, and one surface thereof may be coated with a diffusion layer including, for example, titanium dioxide.

In an embodiment, the reflective sheet 430 may include a material that includes a metal such as silver (Ag).

The lower frame 440 accommodates therein the light source member 450, the optical sheet 410, the reflective sheet 430 and the light guide plate 420. The lower frame 440 may have a roundly curved shape.

The lower frame 440 may include a relatively rigid metal material, e.g., stainless steel, or a material having heat dissipation characteristics such as aluminum or aluminum alloy. The lower frame 440 may also be referred to as an ‘extrusion bar’ that performs a heat dissipating function for the light source 451. The lower frame 440 maintains an overall framework of the display device 10 and protects various components housed therein.

In the display device 10 which is curved, in order to increase the light incident efficiency of the light guide plate 420, the light guide plate alignment member 460 is disposed at the display device 10. Hereinbelow, the light guide plate alignment member 460, the light source member 450, and the light guide plate 420 will be described in detail with reference to FIGS. 3 to 11.

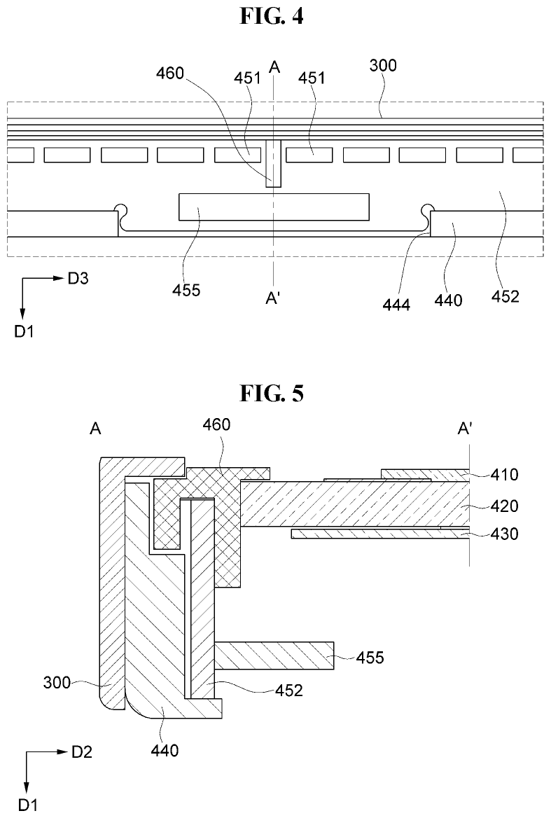

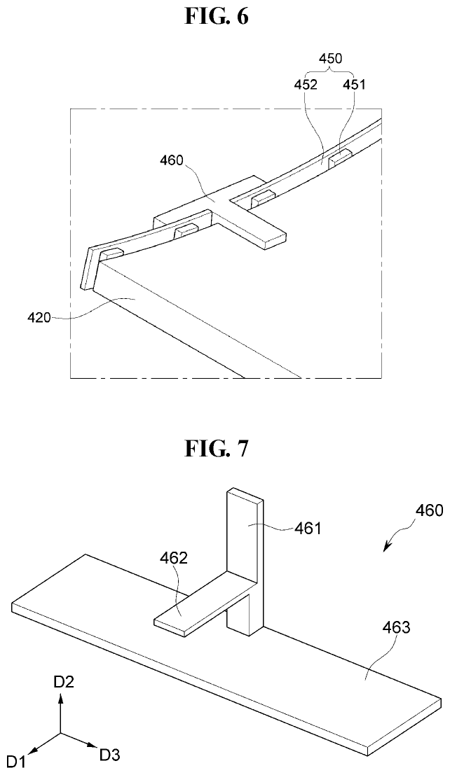

FIG. 3 is a cross-sectional view illustrating an embodiment of the display device taken along line in FIG. 1, FIG. 4 is an enlarged cross-sectional view illustrating the light guide plate alignment member 460 relative to the first circuit board 452, viewed from an inner area of the display device 10 (e.g., from a position of a light guide plate 420 toward the intermediate frame 300), FIG. 5 is a cross-sectional view taken along line A-A′ in FIG. 4, and FIG. 6 is a view illustrating an embodiment of a light guide plate alignment member 460 relative to the frame, the light guide plate 420 and the first circuit board 452. FIG. 5 may be a view in a direction from the right side in FIG. 5 toward the left side in FIG. 5 (e.g., from the light guide plate 420 toward the intermediate frame 300).

Referring to FIGS. 1 to 6, the light guide plate 420 guides and emits the light emitted from the light source member 450 to the display panel 200.

The light source 451 is mounted on the first circuit board 452. The first circuit board 452 provides a power signal to the light source 451, and is disposed at the light incident surface of the light guide plate 420. The light source 451 includes a plurality of LED packages 451.

The frame includes the upper frame 100, the intermediate frame 300 and the lower frame 440. The lower frame 440 may accommodate therein at least one of the display panel 200, the light guide plate 420 and the first circuit board 452.

The lower frame 440 may be coupled to at least a portion of the light guide plate alignment member 460. As illustrated in FIG. 4, the lower frame 440 may have a second depression 444 into which a portion of the first circuit board 452 is inserted. Accordingly, a portion of the first circuit board 452 is inserted into the second depression 444, and thus the first circuit board 452 may be secured to the lower frame 440. In a plane defined by two directions crossing each other (e.g., horizontal and vertical directions in FIG. 4), movement of the first circuit board 452 may be restricted along the horizontal direction by portions of the lower frame 440 at second depression 444.

In such an embodiment, the first circuit board 452 may include a printed circuit board (“PCB”) connector 455 through which the first circuit board 452 receives power from outside thereof, and may be connected to an external power source (not illustrated) through the PCB connector 455.

The light guide plate alignment member 460 is coupled to the frame, and is disposed between the first circuit board 452 and the light guide plate 420 to guide the light guide plate 420 into a position thereof within the frame. That is, as the light guide plate alignment member 460 contacts an upper surface of the first circuit board 452 and contacts an upper surface of the light guide plate 420, as illustrated in FIG. 6, the light guide plate alignment member 460 guides the light source 451 mounted on the first circuit board 452 so that the light source 451 may face the light incident surface of the light guide plate 420.

The first circuit board 452 has a curvature along a curved side of the light guide plate 420 as described above. Referring again to FIG. 1, for example, two relatively long sides of the light guide plate 420 have a curved shape, and the first circuit board 452 has a substantially same curvature corresponding to the curvature of the relatively long sides of the light guide plate 420.

As the first circuit board 452 and the light guide plate 420 are disposed in such a manner, light incident efficiency of the light guide plate 420 may increase. That is, as the light guide plate alignment member 460 pressing against the first circuit board 452 together with the light guide plate 420, the light source 451 and the light incident surface of the light guide plate 420 are aligned with each other, and accordingly, light incident efficiency of the light guide plate 420 may increase.

In an embodiment, if the light incident efficiency of the light guide plate 420 is increased, a desired light quantity within the display device 10 may be obtained even with a smaller number of light sources 451 than the conventional one. Accordingly, the manufacturing cost of the display device 10 may be reduced by reducing the number of the light sources 451.

The light guide plate alignment member 460 may be disposed between LED packages 451 which are adjacent to each other, as illustrated in FIG. 4. That is, along a length of the first circuit board 452, the light guide plate alignment member 460 is disposed between light emitting diode packages 451 which are adjacent to each other. In such an embodiment, as illustrated along the horizontal direction in FIG. 5, a first end of an upper end portion of the light guide plate alignment member 460 may contact a portion (e.g., a portion of the light exit surface) of the light guide plate 420, and extend from the light guide plate 420 to contact an upper end portion of the first circuit board 452. The light guide plate alignment member 460 may further extend from the upper end portion of the first circuit board 452, along a thickness direction of the display device 10, to be disposed facing a rear surface of the first circuit board 452 (e.g., the left vertical surface of the first circuit board 452 shown in FIG. 5).

The light guide plate alignment member 460 may be coupled to one of the lower frame 440 and the first circuit board 452. In an embodiment, the light guide plate alignment member 460 may be coupled to the lower frame 440 or to the first circuit board 452 in a screw manner.

The light guide plate alignment member 460 may include a first alignment portion 461, a gap maintaining portion 462, and a securing portion 463, as illustrated in FIG. 5.

The first alignment portion 461 contacts an upper surface of the first circuit board 452 and an upper surface of the light guide plate 420. The gap maintaining portion 462 extends in a first direction D1 from a surface of the first alignment portion 461, and maintains a gap between the first circuit board 452 and the light guide plate 420. The securing portion 463 extends in parallel to the gap maintaining portion 462 from a surface of the first alignment portion 461 and is secured to the lower frame 440.

The first circuit board 452 may have a coupling depression 453 for accommodating at least a portion of the first alignment portion 461.

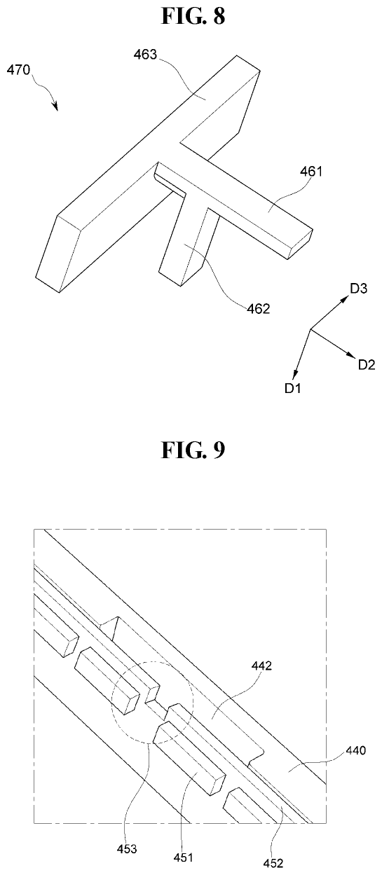

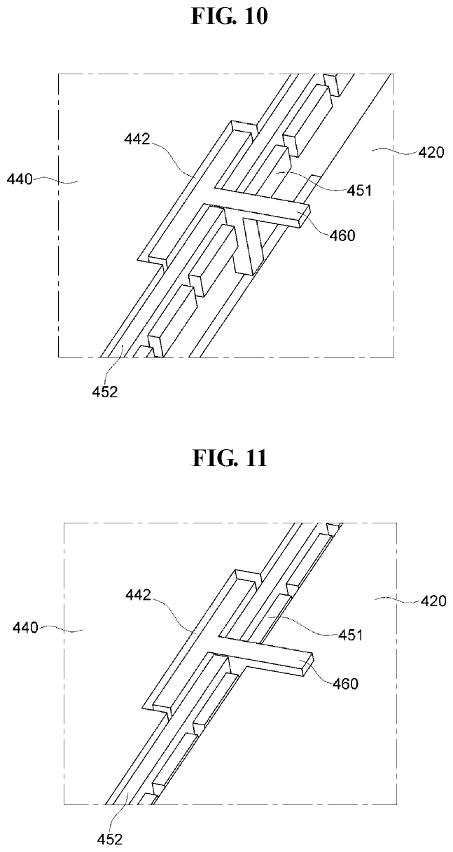

FIG. 7 is a view illustrating an embodiment of a light guide plate alignment member 460, FIG. 8 is a view illustrating the light guide plate alignment member 460 viewed from a different angle than FIG. 7, FIG. 9 is an enlarged view illustrating an embodiment of a connection structure of the first circuit board 452 and a frame, FIG. 10 is a view illustrating an embodiment of a connection structure in which a light guide plate alignment member 460 is coupled to a first circuit board 452 and a frame, before alignment of such connection structure with a light guide plate 420; and FIG. 11 is a view illustrating an embodiment of a light guide plate alignment member 460 connected to a frame, a first circuit board 452, and a light guide plate 420.

Referring to FIGS. 7 to 11, the light guide plate alignment member 460 may include the first alignment portion 461, the gap maintaining portion 462, and the securing portion 463.

The first alignment portion 461 contacts an upper surface of the first circuit board 452 and an upper surface of the light guide plate 420. In detail, a lower surface of the first alignment portion 461 contacts the upper surface of the first circuit board 452 and the upper surface of the light guide plate 420, and an upper surface of the first alignment portion 461 is opposite to the lower surface thereof.

In such an embodiment, a portion of the first alignment portion 461 at a distal end thereof that contacts the upper surface of the first circuit board 452 may have a thickness greater than a thickness of a portion of the first alignment portion 461 that contacts the upper surface of the light guide plate 420. Referring to FIG. 7, for example, a distance between the upper surface of the first alignment portion 461 and the lower surface thereof at the first circuit board 452, which is taken along the first direction D1, is larger than a distance between the upper surface of the first alignment portion 461 and the lower surface thereof at the light guide plate 420. That is, the portion of the first alignment portion 461 that contacts the upper surface of the first circuit board 452 is accommodated in the coupling depression 453 of the first circuit board 452, and thus has a thickness greater than the thickness of the portion of the first alignment portion 461 that contacts the upper surface of the light guide plate 420.

Referring to FIG. 7, along a third direction D3, the first alignment portion 461 may have a width substantially the same as a width of the gap maintaining portion 462. In another embodiment, the first alignment portion 461 may have a width along the third direction D3 which is different from a width of the gap maintaining portion 462 along the third direction D3. In an embodiment, for example, the first alignment portion 461 may have a width greater than the width of the gap maintaining portion 462.

In addition, the first circuit board 452 may have the coupling depression 453 in which is accommodated at least a portion of the first alignment portion 461.

The gap maintaining portion 462 extends in the first direction D1 from the lower surface of the first alignment portion 461 to maintain a gap between the first circuit board 452 and the light guide plate 420 along a second direction D2 which crosses the first direction D1. That is, the gap maintaining portion 462 keeps the first circuit board 452 and the light guide plate 420 spaced apart from each other by separating the first circuit board 452 and the light guide plate 420 from each other by the thickness of the gap maintaining portion 462 which is taken along the second direction D2.

The securing portion 463 extends along the first direction D1 to be in parallel with the gap maintaining portion 462, from the first alignment portion 461 and is secured to the lower frame 440. In such an embodiment, the lower frame 440 may have a first depression 442 for accommodating the securing portion 463, as illustrated in FIG. 9. Accordingly, the securing portion 463 may be accommodated at the first depression 442 of the lower frame 440, and then secured to the lower frame 440 with, for example, a screw.

The first depression 442 of the lower frame 440 may be a recess in a sidewall of the lower frame 440, which extends from an inner area of the lower frame 440 toward the intermediate frame 300 disposed facing an outer surface of the lower frame 440. The sidewall of the lower frame 440 may extend from edges of a bottom portion. The second depression 444 described above may be defined in the bottom portion of the lower frame 440, without being limited thereto.

The lower frame 440 has the first depression 442 in which the securing portion 463 is accommodated. In such an embodiment, along the third direction D3, the first depression 442 has a width greater than a width of the first alignment portion 461, or has a width greater than a width of the gap maintaining portion 462.

The securing portion 463 may extend in parallel to the gap maintaining portion 462, such as perpendicularly from the first alignment portion 461, as illustrated in FIGS. 7 and 8. In such an embodiment, along the first direction D1, the securing portion 463 may have a length less than a length of the gap maintaining portion 462. In addition, along the third direction D3, the securing portion 463 may have a width greater than both a width of the first alignment portion 461 and a width of the gap maintaining portion 462. That is, since the securing portion 463 is accommodated at the first depression 442 of the lower frame 440, the securing portion 463 has a width greater than a width of the first alignment portion 461 and/or greater than a width of the gap maintaining portion 462.

Since a portion of the first alignment portion 461 that overlaps the first circuit board 452 is accommodated in the coupling depression 453 thereof, the upper surface of the first alignment portion 461 is located on a line substantially the same as a line on which an upper surface of the first circuit board 452 is located, as illustrated in FIGS. 10 and 11. That is, the upper surface of the first alignment portion 461 and the upper surface of the first circuit board 452 may be coplanar with each other.

Accordingly, since the securing portion 463 is accommodated within the first depression 442 to be disposed below an upper surface of the lower frame 440, the upper surface of the securing portion 463 is located below the upper surface of the lower frame 440. Referring to FIG. 11, a connected structure of light guide plate alignment member 460 with both the lower frame 440 and the first circuit board 452, disposes the sidewall of the lower frame 440 in which the first depression 442 is defined, protruding further along the first direction than the securing portion 463, and disposes the upper surface of the securing portion 463 not coplanar with (e.g., below) the upper surface of the lower frame 440 at the first depression 442 thereof.

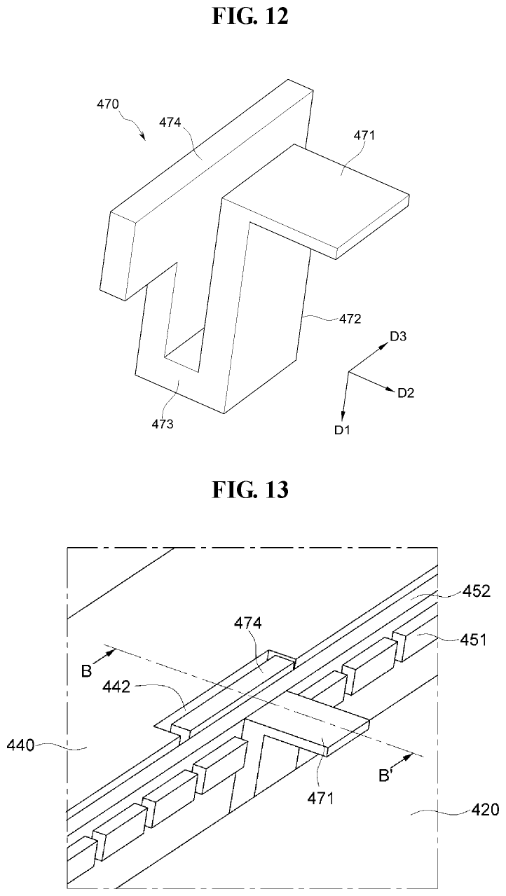

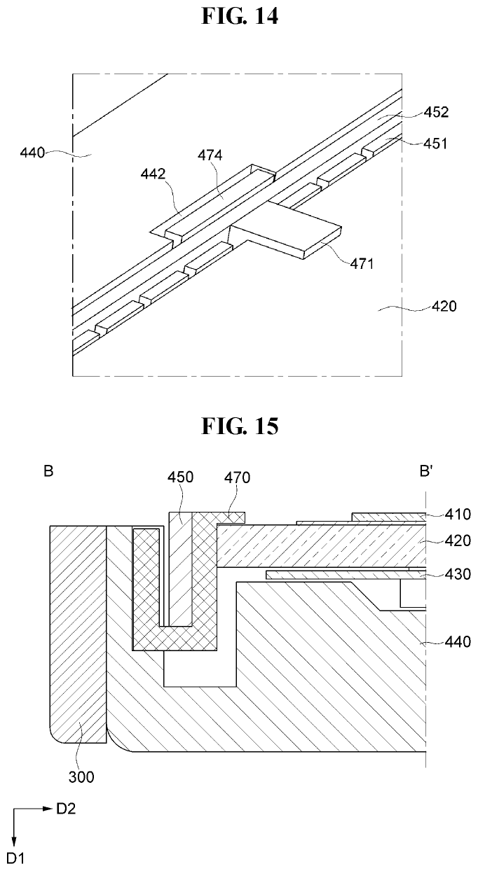

FIG. 12 is a view illustrating another embodiment of a light guide plate alignment member, FIG. 13 is a view illustrating an embodiment of a connection structure in which a light guide plate alignment member 470 is coupled to a first circuit board 452 and a frame, before alignment of such connection structure with a light guide plate, FIG. 14 is a view illustrating an embodiment of a light guide plate alignment member 470 connected to a frame, a first circuit board 452, and a light guide plate 420, and FIG. 15 is a cross-sectional view taken along line B-B′in FIG. 13.

Referring to FIGS. 12 to 15, a light guide plate alignment member 470 includes a first alignment portion 471, a gap maintaining portion 472, a second alignment portion 473, and a securing portion 474.

The first alignment portion 471 contacts an upper surface of the light guide plate 420. That is, the first alignment portion 471 contacts a portion of the upper surface of the light guide plate 420 by a length of extension in the second direction D2 from the gap maintaining portion 472.

The gap maintaining portion 472 extends in the first direction D1 from a lower surface of the first alignment portion 471 and maintains a gap between the first circuit board 452 and the light guide plate 420 along the second direction D2. That is, the gap maintaining portion 472 maintains a gap between the first circuit board 452 and the light guide plate 420 by separating the first circuit board 452 and the light guide plate 420 from each other by a thickness of the gap maintaining portion 472, along the second direction D2.

The second alignment portion 473 extends along the second direction D2 from an inner surface of the gap maintaining portion 472 and contacts a lower surface of the first circuit board 452 (e.g., a surface of the first circuit board 452 furthest along the first direction D1). That is, the second alignment portion 473 extends from the gap maintaining portion 472 in direction which is opposite to the second direction D2 (e.g., opposite to the extension direction of the first alignment portion 471), and contacts the lower surface of the first circuit board 452.

The lower frame 440 may have the first depression 442 which is defined therein, in which the securing portion 474 of the light guide plate alignment member 470 is accommodated.

The securing portion 474 extends along a direction which is opposite to the first direction D1 from an upper surface of the second alignment portion 473 and is secured to the lower frame 440, such as at a sidewall thereof. That is, the securing portion 474 extends from the second alignment portion 473 in a direction which is opposite to the extension direction of the gap maintaining portion 472 from the first alignment portion 471, and an upper end portion (e.g., a distal end) of the securing portion 474 is accommodated at the first depression 442 of the lower frame 440 to be secured to the lower frame 440.

In such an embodiment, the light guide plate alignment member 470 may be coupled to one of the lower frame 440 or the first circuit board 452 in a screw manner.

The first alignment portion 471 may have a width substantially the same as a width of the gap maintaining portion 472, along the third direction D3, as illustrated in FIG. 12.

In another embodiment, although not illustrated, the first alignment portion 471 may have a width different from a width of the gap maintaining portion 472 along the third direction D3. That is, the first alignment portion 471 may have a width greater than a width of the gap maintaining portion 472, along the third direction D3.

The securing portion 474 may have a width different from a width of the first alignment portion 471, along the third direction D3, as illustrated in FIG. 12. That is, the securing portion 474 may have a width greater than a width of the first alignment portion 471, along the third direction D3.

The first alignment portion 471 extends from the gap maintaining portion 472 in the second direction D2 and contacts an upper surface (e.g., the light exit surface) of the light guide plate 420, and the second alignment portion 473 extends from the gap maintaining portion 472 in a direction which is opposite to the second direction D2 and contacts a lower surface of the first circuit board 452.

The gap maintaining portion 472 may have a thickness different from a thickness of the first alignment portion 471, along the second direction D2. That is, the gap maintaining portion 472 may have a thickness greater than a thickness of the first alignment portion 471, along the second direction D2.

The gap maintaining portion 472 extends from the first alignment portion 471 in the first direction D1, and the securing portion 474 extends from the second alignment portion 473 in a direction opposite to the first direction D1.

The securing portion 474 extends from the second alignment portion 473 in a direction opposite to the first direction with a width substantially the same as a width of the second alignment portion 473 (e.g., widths taken along the third direction D3), and is accommodated at the first depression 442 of the lower frame 440 with a width greater than a width of the second alignment portion 473 along the third direction D3.

As illustrated in FIG. 15, an upper end portion of the light guide plate alignment member 470 may contact a portion of the light guide plate 420 (e.g., both a light incident surface and a light exit surface of the light guide plate 420), and a lower end portion of the light guide plate alignment member 470 may contact a lower end portion of the first circuit board 452 and extend to be disposed facing a rear surface of the first circuit board 452.

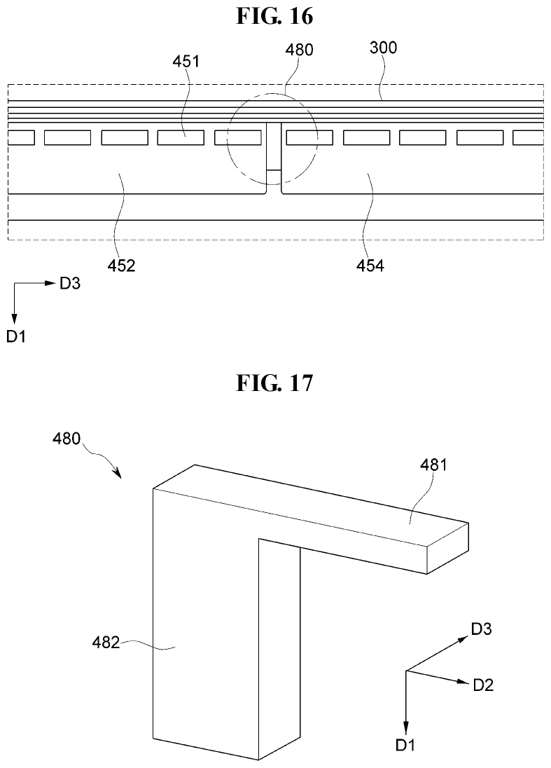

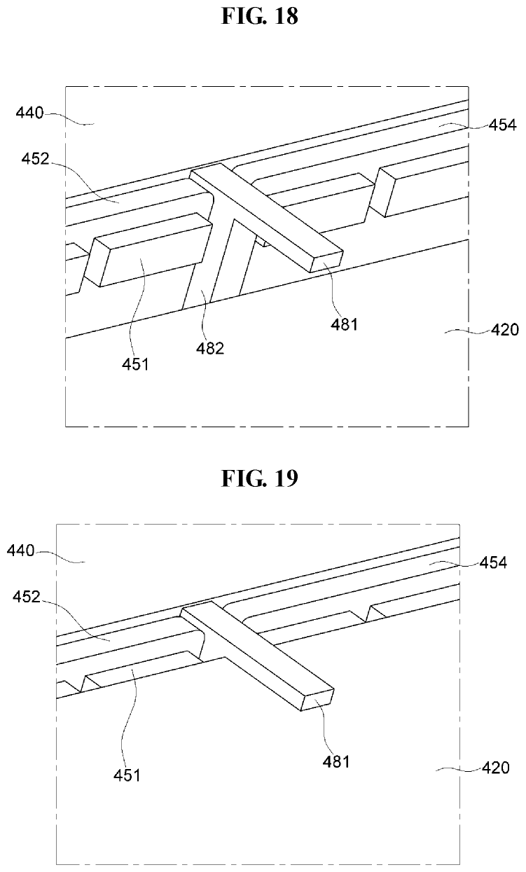

FIG. 16 is an enlarged cross-sectional view illustrating a light guide plate alignment member 480 between two circuit boards, viewed from an inner area of the display device 10 (e.g., from a position of a light guide plate 420 toward the intermediate frame 300). FIG. 17 is a view illustrating still another embodiment of a light guide plate alignment member 480. FIG. 18 is a view illustrating an embodiment of a connection structure in which a light guide plate alignment member 480 is coupled to two circuit boards and a frame, before alignment of such connection structure with a light guide plate 420. FIG. 19 is a view illustrating an embodiment of a light guide plate alignment member 480 connected to a frame, two circuit boards, and a light guide plate 420.

Referring to FIGS. 16 to 19, a light guide plate alignment member 480 may be disposed between a first circuit board 452 and a second circuit board 454, along the third direction D3. That is, the first circuit board 452 and the second circuit board 454 are spaced apart from each other by a predetermined distance, and the light guide plate alignment member 480 may be disposed within a predetermined gap between the first circuit board 452 and the second circuit board 454.

Referring to FIGS. 1 to 19, the light source member 450 provides light to the display panel 200. The light guide plate 420 guides the light emitted from the light source member 450 to the display panel 200.

The first circuit board 452 and the second circuit board 454 provide a power signal to the light source member 450 and are positioned facing a same one of the light incident surface of the light guide plate 420.

The lower frame 440 accommodates therein at least one of the display panel 200, the light guide plate 420, and the first circuit board 452 and the second circuit board 454.

The light guide plate alignment member 480 is secured to the lower frame 440. The light guide plate alignment member 480 is disposed between the lower frame 440 and the light guide plate 420 (e.g., along the second direction D2) and between the first circuit board 452 and the second circuit board 454, to guide a position of the light guide plate 420 within the display device 10.

The light guide plate alignment member 480 includes a first alignment portion 481 and a gap maintaining portion 482, as illustrated in FIG. 17.

The first alignment portion 481 contacts an upper surface of the light guide plate 420. That is, the first alignment portion 481 has a flat rectangular parallelepiped shape, and protrudes from the gap maintaining portion 482 in the second direction D2 to contact an upper surface (e.g., a light exit surface) of the light guide plate 420.

The gap maintaining portion 482 extends from a lower surface of the first alignment portion 481 in the first direction D1 to maintain a gap between the first circuit board 452 and the light guide plate 420 along the second direction D2. That is, the gap maintaining portion 482 maintains a gap between the first circuit board 452 and the light guide plate 420 by separating the first circuit board 452 and the light guide plate 420 from each other, by the thickness of the gap maintaining portion 482, along the second direction D2.

Along the third direction D3, the first alignment portion 481 may have a width less than a width of the gap maintaining portion 482.

When the gap maintaining portion 482 is disposed between the first circuit board 452 and the second circuit board 454, an upper end surface of the first alignment portion 481 is located on a line substantially the same as a line on which an upper end surface of both the first circuit board 452 and an upper end surface of the second circuit board 454 are located. That is, the upper surface of the first alignment portion 481 and the upper surfaces of the first circuit board 452 and the second circuit board 454 may be coplanar with each other.

The gap maintaining portion 482 has a thickness greater than a thickness of the first alignment portion 481. Referring to FIG. 17, for example, along a thickness direction (e.g., first direction D1) of the display device 10, a thickness of the gap maintaining portion 482 is greater than the thickness of the first alignment portion 481. By adjusting the thicknesses, a gap between the light guide plate 420 and the circuit boards 452 and 454 may be adjusted.

As described above, according to one or more embodiment, a display device has an alignment structure of a light source and a light guide plate so that light emitted from the light source is incident to the light guide plate without loss, to maximize light efficiency within the display device.

As set forth hereinabove, a display device according to one or more embodiments may increase light incident efficiency of a light guide plate, reduce or substantially prevent light leakage that may occur at an edge of the light guide plate, reduce power consumption of the display device, and reduce manufacturing costs of the display device.

In addition, when a printed circuit board including a light source mounted thereon is attached to the light guide plate, a dimensional tolerance of a gap between the printed circuit board and a mold (e.g., a mold frame) may be reduced.

In addition, when the light guide plate is provided between LED packages along a length of a circuit board, it is possible to increase luminance by disposing relatively more LED packages on the printed circuit board since there is no interfering structure between the LED packages.

In addition, a hot spot risk owing to LED packages spaced apart from each other may be reduced by narrowing a distance between the LED packages.

While the invention has been illustrated and described with reference to the embodiments thereof, it will be apparent to those of ordinary skill in the art that various changes in form and detail may be made thereto without departing from the spirit and scope of the invention.

What is claimed is:

1. A display device comprising:
a display panel;
a light source which generates light;
a light guide plate which guides the light from the light source and emits the light to the display panel, the light guide plate comprising a light incident surface through which the light is incident to the light guide plate from the light source;
a circuit board which provides power to the light source and is disposed facing the light incident surface of the light guide plate;
a light guide plate alignment member disposed between the circuit board and the light incident surface of the light guide plate; and
a frame in which the light guide plate and the circuit board are accommodated and to which the light guide plate alignment member is coupled,
wherein the light guide plate alignment member comprises:
a gap maintaining portion between the circuit board and the light incident surface of the light guide plate;
a securing portion with which the light guide plate alignment member is coupled to the frame, the securing portion disposed between the circuit board and the frame, and
a first alignment portion connecting the gap maintaining portion and the securing portion to each other with the circuit board therebetween, the first alignment portion contacting both an upper surface of the circuit board and an upper surface of the light guide plate.

2. The display device of claim 1, wherein
the frame comprises an upper frame, a lower frame, and an intermediate frame between the upper frame and the lower frame, and
the lower frame is coupled to the light guide plate alignment member at the securing portion thereof.

3. The display device of claim 1, wherein
the light source comprises a plurality of light emitting diode packages, and
along the light incident surface of the light guide plate, the gap maintaining portion of the light guide plate alignment member is disposed between light emitting diode packages which are adjacent to each other.

4. The display device of claim 1, wherein the circuit board defines a coupling depression in which the first alignment portion of the light guide plate alignment member is accommodated, the first alignment portion contacting the upper surface of the circuit board at the coupling depression thereof.

5. The display device of claim 1, wherein along a thickness direction of the display device a thickness of a portion of the first alignment portion at which the upper surface of the circuit board contacts the first alignment portion is greater than a thickness of a portion of the first alignment portion at which the upper surface of the light guide plate contacts the first alignment portion.

6. The display device of claim 1, wherein along the light incident surface of the light guide plate, a width of the first alignment portion is equal to a width of the gap maintaining portion.

7. The display device of claim 1, wherein along the light incident surface of the light guide plate, a width of the first alignment portion is different from a width of the gap maintaining portion.

8. The display device of claim 7, wherein along the light incident surface of the light guide plate, the width of the first alignment portion is greater than the width of the gap maintaining portion.

9. The display device of claim 1, wherein along a thickness direction of the display device, the securing portion extends perpendicularly from the first alignment portion and is parallel to the gap maintaining portion.

10. The display device of claim 9, wherein along the light incident surface of the light guide plate, a width of the securing portion is greater than a width of the first alignment portion and a width of the gap maintaining portion.

11. The display device of claim 1, wherein the frame defines a first depression of the frame in which the securing portion is accommodated to couple the frame to the light guide plate alignment member.

12. The display device of claim 11, wherein the frame defines a second depression of the frame into which a portion of the circuit board extends.

13. A display device comprising:
a display panel;
a light source which generates light;
a light guide plate which guides the light from the light source and emits the light to the display panel, the light guide plate comprising a light incident surface through which the light is incident to the light guide plate from the light source;
a circuit board which provides power to the light source and is disposed facing the light incident surface of the light guide plate;
a light guide plate alignment member disposed between the circuit board and the light incident surface of the light guide plate; and
a frame in which the light guide plate and the circuit board are accommodated and to which the light guide plate alignment member is coupled,
wherein the light guide plate alignment member comprises:
a first alignment portion contacting an upper surface of the light guide plate;
a gap maintaining portion extending from the first alignment portion to be disposed between the circuit board and the light incident surface of the light guide plate;
a securing portion with which the light guide plate alignment member is coupled to the frame, the securing portion disposed between the circuit board and the frame; and
a second alignment portion connecting the gap maintaining portion and the securing portion to each other with the circuit board therebetween, the second alignment portion contacting a lower surface of the circuit board.

14. The display device of claim 13, wherein the frame defines a first depression of the frame in which the securing portion is accommodated to couple the frame to the light guide plate alignment member.

15. The display device of claim 13, wherein along the light incident surface of the light guide plate, a width of the first alignment portion is equal to a width of the gap maintaining portion.

16. The display device of claim 13, wherein along the light incident surface of the light guide plate, a width of the first alignment portion is different from a width of the gap maintaining portion.

17. The display device of claim 13, wherein along the light incident surface of the light guide plate, a width of the securing portion is different from a width of the first alignment portion.

18. The display device of claim 17, wherein along the light incident surface of the light guide plate, the width of the securing portion is greater than the width of the first alignment portion.

19. The display device of claim 13, wherein along a thickness direction of the display device, a thickness of the gap maintaining portion is different from a thickness of the first alignment portion.

20. The display device of claim 19, wherein along a thickness direction of the display device, a thickness of the gap maintaining portion is greater than the thickness of the first alignment portion.
